(19) United States
(12) Patent Application Publication
(10) Pub. No.: US 2012/0051034 A1
(43) Pub. Date: Mar. 1, 2012

(54) HOOK METER WITH IMPROVED ILLUMINATION

(76) Inventor: SHAW-LIN LIU, Shu Lin City (TW)

(21) Appl. No.: 12/873,327

(22) Filed: Sep. 1, 2010

(51) Int. Cl. F21V 33/00

(52) U.S. Cl. 362/109

(57) ABSTRACT

The hook meter contains a body member, a static arm, a moveable arm, both extended from a top end of the body member. The static and moveable arms are shaped so that each has a side surface rests against each other, thereby forming a closed area. On a spot of the static arm where it is not covered by the moveable arm, a light generation element is provided. As such, the light generation element's light is not blocked by the static and moveable arms, whether they are closed together or separated apart. The hook meter therefore could be conveniently operated in a dark or dimly lit environment.

### TECHNICAL FIELD OF THE INVENTION

The present invention generally relates to hook meters, and more particular to a hook meter having a light generation element whose light is not blocked by the arms of the hook meter.

### Description of the Prior Art

As shown in FIG. 4, a conventional hook meter contains a body member 20, a curved static arm 21, and a curved pin-joined moveable arm 22, both at a front end of the body member 20. Normally, a front surface of the moveable arm 22 rests against a front surface of the static arm 21, forming a closed circular area 20a. A light generation element 23 is positioned within the circular area 20a also at the front end of the body member 20. With the light produced by the light generation element 23, the hook meter could be operated in a poorly lit environment.

As shown in FIG. 3, the light generation element 23 projects light beams L1 with a coverage angle A1 and, when the moveable arm 22 is not opened, the area behind the static and moveable aims 21 and 22 are blocked, comprising the illumination effect of the light generation element 23. Even when the moveable arm 22 is opened, still a portion of the area is blocked, not only by the static and moveable arms 21 and 22, but also by the cables or wires under test. As such, the hook meter is rather inconvenient for an operator to work in dark surroundings.

### SUMMARY OF THE INVENTION

A hook meter according to the present invention contains a body member, a static arm, a moveable arm, both extended from a front end of the body member. The static and moveable arms are shaped so that each has a side surface rests against each other, thereby forming a closed area. On a spot of the static arm where it is not covered by the moveable arm, a light generation element is provided. As such, the light generation element's light is not blocked by the static and moveable arms, whether they are closed together or separated apart. The hook meter as such could be conveniently operated in a dark or dimly lit environment.

The light generation element is configured on a side surface of the static arm that interfaces the moveable arm aiming at a lateral direction, or on a top surface of static arm that is higher than the moveable arm aiming at a front direction. When an operator engages the moveable arm and opens the closed area, the light generation element is automatically turned on. The light beams from the light generation element have a coverage angle that covers the gap between the moveable and the static arms.

The light generation element could be a light emitting diode or an incandescent light bulb.

The present invention has the following advantages. First, the light from the light generation element is not confined by the closed area of the hook meter and the light generation element is automatically turned on when the moveable arm is opened. Secondly, the light is not blocked by the static and moveable arms, whether they are closed or opened. In addition, when in a dark, limited space with a large number of cables or wires, by slightly opening the moveable arm, the light generation element is turned on. In contrast, the arms of prior art has to be widely opened in order to gain a better illumination effect, making prior art a less convenient tool.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a hook meter according to an embodiment of the present invention.

FIG. 2 is a schematic diagram showing the hook meter of FIG. 1.

FIG. 3 is a schematic diagram showing a hook meter according to another embodiment of the present invention.

FIG. 4 is a schematic diagram showing a conventional hook meter.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

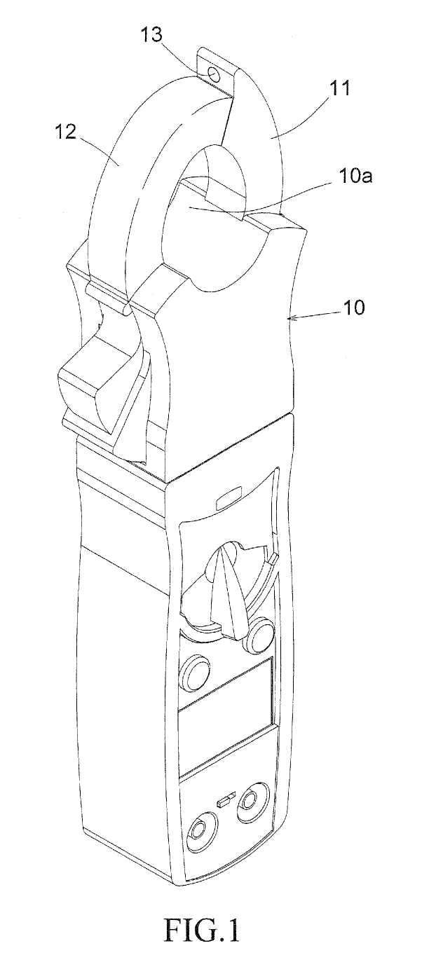

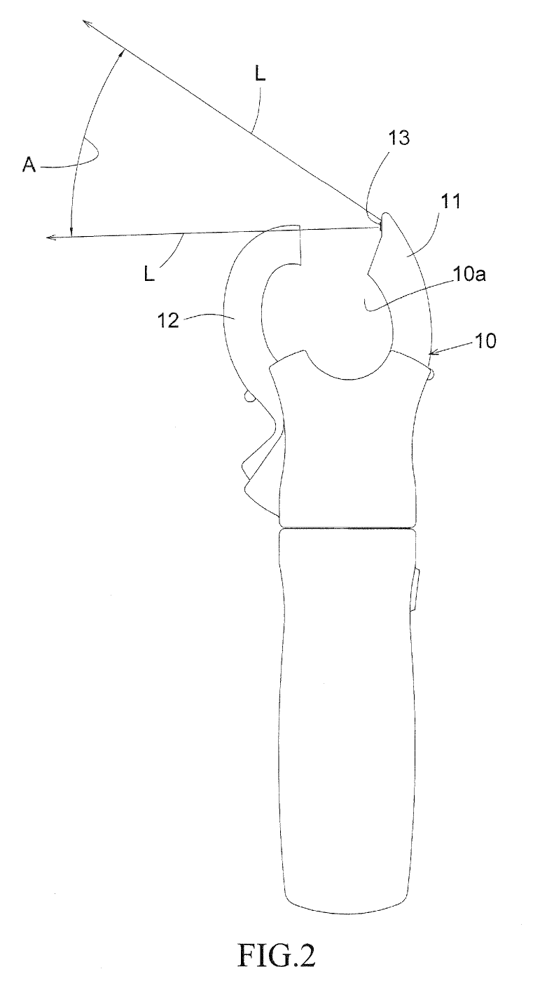

As shown in FIGS. 1 and 2, a hook meter according to an embodiment of the present invention contains a body member 10, a curved static arm 11 extended from a front end of the body member 10, a curved moveable arm 12 extended from and pin-joined also to the front end of the body member 10. The static and moveable arms 11 and 12 are shaped so that their front surfaces rest against each other, thereby forming a closed area 10a. On a spot of the static arm 11 where it is not covered by the moveable arm 12, a light generation element 13 is provided. As illustrated in FIG. 2, the light generation element 13's light is not blocked by the static and moveable arms 11 and 12, whether they are closed together or separated apart. The hook meter as such could be conveniently operated in a dark or dimly lit environment.

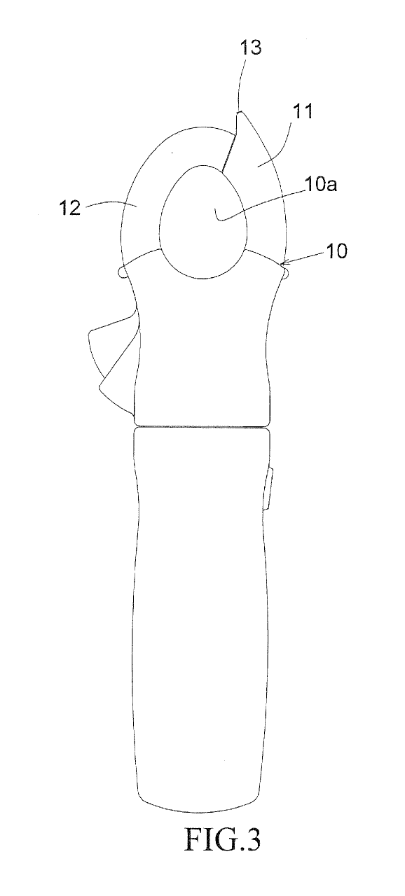

More specifically, the light generation element 13 is configured on a side surface of the static arm 11 that interfaces the moveable arm 12 aiming at a lateral direction, or, as shown in FIG. 3, on a top surface of static arm 11 that is higher than the moveable arm 12 aiming at a front direction. When an operator engages the moveable arm 12 and opens the closed area 10a, the light generation element 13 is automatically turned on. The light beams L from the light generation element 13 have a coverage angle A that covers the gap between the moveable arm 12 and the static arm 11. As such, an operator could have a clear view of the cables or wires under test.

The present invention does not limit the light generation element 13. It could be a light emitting diode or an incandescent light bulb.

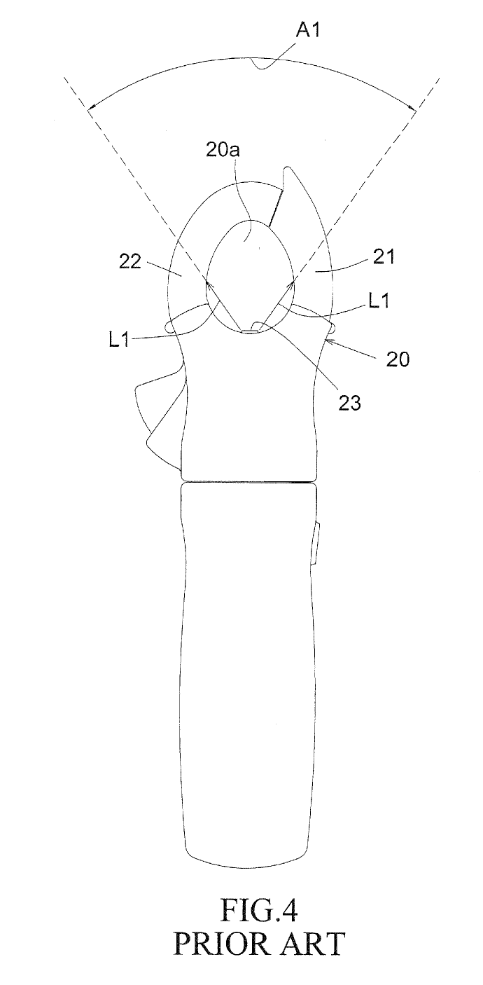

As shown in FIG. 2, the light generation element 13 is not located within the closed, area 10a and therefore the light beams L are not blocked by the static and moveable arms 11 and 12. All objects within the coverage angle A are will lit. In comparison, as shown in FIG. 4, not only the light beams L1 of the prior art are blocked, but also the shadows rendered on the cables or wires under test make the test or measurement operation even more difficult.

The present invention has the following advantages. First, the light from the light generation element 13 is not confined by the closed area 10a of the hook meter. Secondly, the light is not blocked by the static and moveable arms 11 and 12, whether they are closed or opened. Moreover, when in a dark, limited space with a large number of cables or wires, by slightly opening the moveable arm 12, the light generation element 13 is turned on. In contrast, the arms of prior art has to be widely opened in order to gain a better illumination effect.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A hook meter, comprising:
a body member;
a curved moveable arm extended from and pin-joined to a top end of said body member; and
a curved static arm extended from said front end of said body member; and a side surface of said moveable arm resting against a side surface of said static arm, thereby forming a closed area between said static, moveable arms and said body member;
a light generation element on a spot of said static arm that is not covered by said moveable arm and light from said light generation element is not blocked said static and moveable arms;
wherein said light generation element is automatically turned on when said moveable arm is engaged to open said closed area.

2. The hook meter according to claim 1, wherein said light generation element is configured on said side surface of said static arm aiming at a lateral direction.

3. The hook meter according to claim 1, wherein said light generation element is configured on a top surface of said static arm that is higher than said moveable arm aiming at a front direction.

4. The hook meter according to claim 1, wherein said light generation element is a light emitting diode.

5. The hook meter according to claim 1, wherein said light generation element is an incandescent light bulb.
